(19) United States
(12) Patent Application Publication
(10) Pub. No.: US 2017/0346635 A1
(43) Pub. Date: Nov. 30, 2017

(54) USER AUTHENTICATION DEVICE

(71) Applicant: HEWLETT-PACKARD DEVELOPMENT COMPANY, L.P., HOUSTON, TX (US)

(72) Inventors: JEREMY GUMMESON, PALO ALTO, CA (US); MARY G BAKER, PALO ALTO, CA (US); ANIMESH SRIVASTAVA, DURHAM, NC (US)

(21) Appl. No.: 15/535,796

(22) PCT Filed: Feb. 20, 2015
(86) PCT No.: PCT/US15/16958

§ 371 Date: Jun. 14, 2017

(51) Int. Cl. H04L 9/32; G06F 1/16; G06F 21/32; G06K 7/10

(52) U.S. Cl. CPC H04L 9/3234; G06K 7/10158; G06F 1/16; G06F 21/32; G06F 2221/21

(57) ABSTRACT

Examples disclosed herein involve a user authenticator that harvests energy from signals. An example involves an authentication manager to provide authentication information to an authorization device to enable access to a secure device in response to receiving a request signal from the authorization device for the authentication Information a power manager to harvest energy from the request signal to power the apparatus.

### BACKGROUND

Security measures are often taken to prevent potential intruders from accessing locations, devices, or information without authorization. There are a variety of locks and mechanisms that may he used to prevent unauthorized access to such secure locations or secure devices. For example, physical keys, digital keys, badges, passwords, certificates, digital wallets, identity cards, and the like, may be used to provide access to secured locations, devices, or information.

### BRIEF DESCRIPTION OF THE DRAWINGS

FIG. 1 illustrates an example authentication system that may implement an example authenticator in accordance with an aspect of this disclosure.

FIG. 2 a block diagram of an example user authenticate that may be implemented by the authentication system of FIG. 1 in accordance with an aspect of this disclosure.

FIG. 3 is a block diagram of an example power manager that may be implemented by the example user authenticator of FIG. 2 in accordance with an aspect of this disclosure.

FIG. 4 is an example implementation of a user authenticated ring that may be used to implement the user authenticator of FIG. 1 or 2 in accordance with an aspect of this disclosure.

FIG. 5 illustrates an example environment of use to implement the user authenticator of FIG. 1 or 2 or the user authenticator ring of FIG. 4 in accordance with an aspect of this disclosure.

FIG. 8 is a flowchart representative of example machine readable instructions that may be executed to Implement the power manager of FIG. 3 in accordance with an aspect of this disclosure.

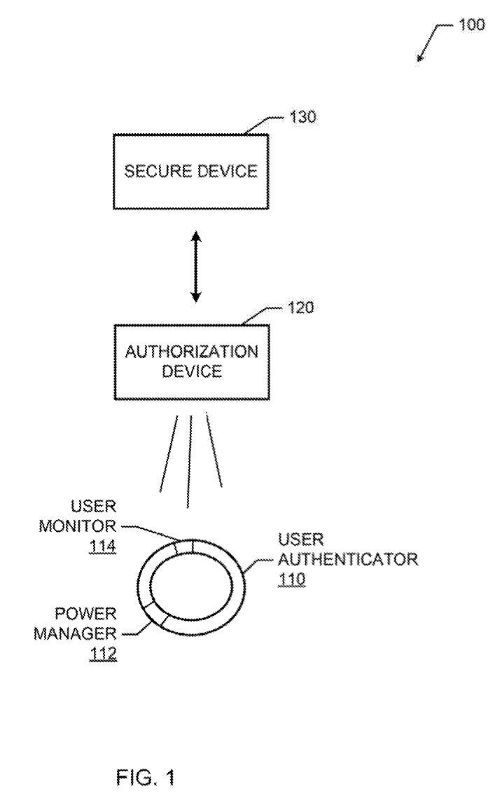

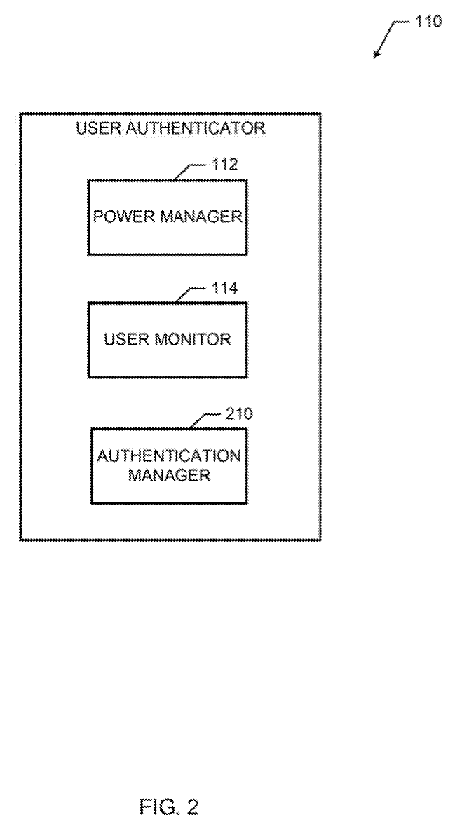

FIG. 7 is a flowchart representative of example machine readable instructions that may he executed to implement a user monitor of the user authenticator of FIG. 1 or 2 in accordance with an aspect of this disclosure.

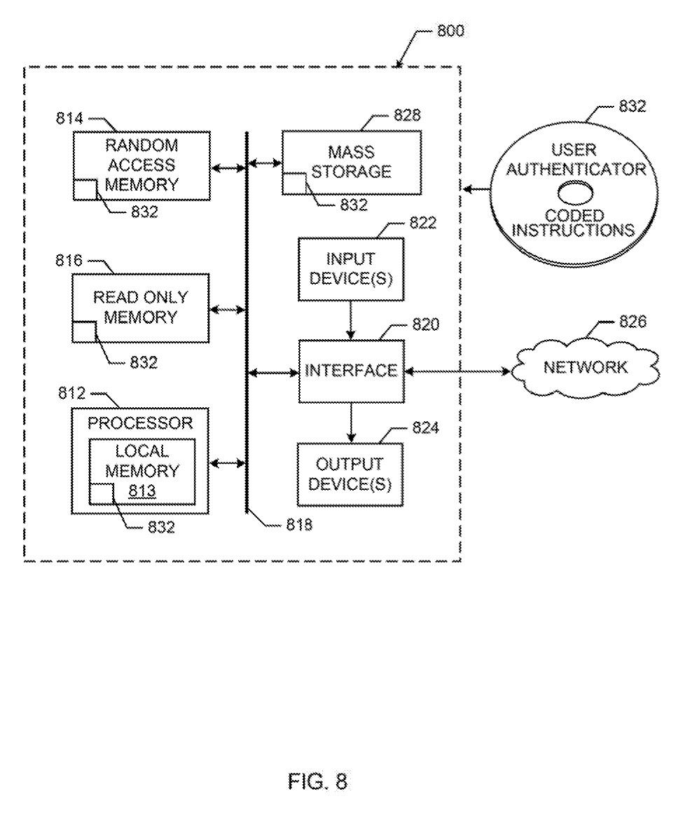

FIG. 8 is a block diagram of an example processor platform capable of executing the instructions of FIG. 6 or 7 to implement the user authenticator of FIG. 1 or 2.

The figures are not to scale. Wherever possible, the same reference numbers will be used throughout the drawing(s) and accompanying written description to refer to the same or like parts. As used in this patent, stating that any part (e.g., a layer, film, area, or plate) is in any way positioned on (e.g., positioned on, located on, disposed on, or formed on, etc.) another part, means that the referenced part is either in contact with the other part, or that the referenced part is above the other part with at least one intermediate part located there between. Stating that any part is in contact with another part means that there is no intermediate part between the two parts.

### DETAILED DESCRIPTION

Examples disclosed herein are related to an authentication device. The authentication device can be used to authenticate a user and subsequently provide access to a secure location, device, or information. Additionally, the authentication device may harvest energy form signals. In an example, the authentication device may be Implemented by a wearable ring device that comes into frequent proximity with devices that emit wireless signals. These wireless signals can contain energy capable of being harvested by the authentication device. In some examples, the user authenticator may monitor user interactions (e.g., based on movement of the user authenticator, based on user touches, etc.) to manage power or functionality of the user authenticator.

Users frequently are asked to authenticate themselves to access a secure location (e.g., a home, a vehicle, a work place, etc.), secure electronic devices (e.g., computers, tablets, phones, etc.), or secure virtual environments (e.g., websites, applications, operating systems, etc.). In many instances, this can be done using keys, passwords, digital badges, identification cards, etc. Examples disclosed herein, involve a convenient user authenticate capable of providing access to any or all secure locations or secure devices, whether they are homes, vehicles, computers, applications, websites, etc. equipped with electronic authorization devices or secure devices (locks). Current techniques for implementing authenticates involve a user carrying another device (e.g., a digital badge). Examples disclosed herein may store authentication information for a plurality of devices.

Furthermore, examples disclosed herein provide a user authenticator that may be powered using signals from external devices, such as authorization devices. In examples disclosed herein, the user authenticated harvests energy from signals (e.g., near field communication (NFC) signals, Bluetooth™ Sow energy BLE signals, etc.) from authorization devices (e.g. NFC devices, BLE devices, radio frequency identification (RFID) devices, etc.) requesting authentication information from the user authenticator. Furthermore, the user authenticated may be disabled when a user removes the user authenticated from his or her person. For example, the user authenticator may monitor when a user removes the user authenticator from his or her finger.

An example method includes detecting a signal requesting authentication information from a user authenticator worn by a user; harvesting energy from the signal requesting the authentication information; and supplying power for the user authenticator, the power generated from the energy.

As used herein, a wearable device is a device that may be positioned on a user or a user's person. As used herein, a user authenticator is a device that authenticates a user and provides authentication information to authorization devices. In examples disclosed herein, authentication information is any information (e.g., a name, a password, an identification number (e.g., social security number, employee identification number, etc,), a user characteristic (e.g., age, sex, birth date), etc,) that may be used to authenticate or identify an individual (e.g., a user).

FIG. 1 illustrates an example authentication system 100 that may Implement an example user authenticator 110 in accordance with an aspect of this disclosure. The authentication system 100 of FIG. 1 includes the user authenticator 110, an authorization device 120, and a secure device 130. The example user authenticator 110 of FIG. 1 includes a power manager 112 and a user monitor 114, each of which may be implemented In accordance with an aspect of this disclosure. In examples disclosed herein, the user authenticator 110 may allow a user access to the secure device 130 via the authorization device 120.

The example user authenticator 110 of FIG. 1 is illustrated as a ring. Accordingly, a user may wear the user authenticator 110 on his or her finger (or other body part) while using the user authenticator 110 to access the secure device 130 via the authorization device 120. In examples disclosed herein, as further described below, the power manager 112 manages power (e.g., utilizing power, storing powers charging a battery, capturing energy, etc.) of the user authenticator 110 and the user monitor 114 monitors interactions between the user authenticator 110 and the user (e.g., to determine that a user is wearing the user authenticator 110, to determine that an authorized user is using the user authenticator 110. etc.). Although the user authenticator 110 of FIG. 1 includes both the power manager 112 and the user monitor 114, in some examples, the user authenticator 110 may include either the power manager 112 or the user monitor 114.

The example authorization device 120 may be any device that requests or retrieves authentication information (e.g., a password, a passcode, an identification code, etc.) from the user authenticator 110. In examples disclosed herein, the authorization device 120 may utilize near frequency communication (NFC), Bluetooth™ low energy (OLE) communication, or any other type of wireless communication to request or retrieve the authentication information from the user authenticator 110. For example, the authorization device 120 may include an NFC device or RFID reader to unlock a door when the user authenticator 110 comes within a proximity of the authorization device 120. As another example, the authorization device 120 may include an NFC device or BLE transceiver that opens or unlocks the secure device or a virtual environment (e.g., an application, a website) of the secure device 130 when the user authenticator 110 establishes a BLE connection with the authorization device 120. Accordingly, as further disclosed below, the user authenticator 110 may include a plurality of devices (e.g., an RFID transponder, an NFC transponder, a BLE transceiver, etc.) that are capable of communicating with the authorization device 120 or other authorization devices using the corresponding type of wireless communication (e.g., NFC, BLE, etc.).

The example secure device 130 may be any device that is used to control security or control secure access for a user to a physical location or electronic device. Accordingly, in examples disclosed herein, the secure device 130 may be a physical lock (e.g., a lock for a door, gate, opening, etc. to a building, an automobile, etc.), or a virtual lock (e.g., a lock to access software, an electronic device, etc.),

Although only a single authorization device 120 and a single secure device 130 are illustrated in the example of FIG. 1, in some examples, the user authenticator 110 may provide access to a plurality of secure devices including (or not including) the secure device 130 via a plurality of authorization devices including (or not including) the authorization device 120. Accordingly, the authenticator 110 may store authentication information (e.g., keys, virtual keys, passwords, pass codes, identification information, etc.) for accessing a plurality of secure devices via a plurality of authorization devices.

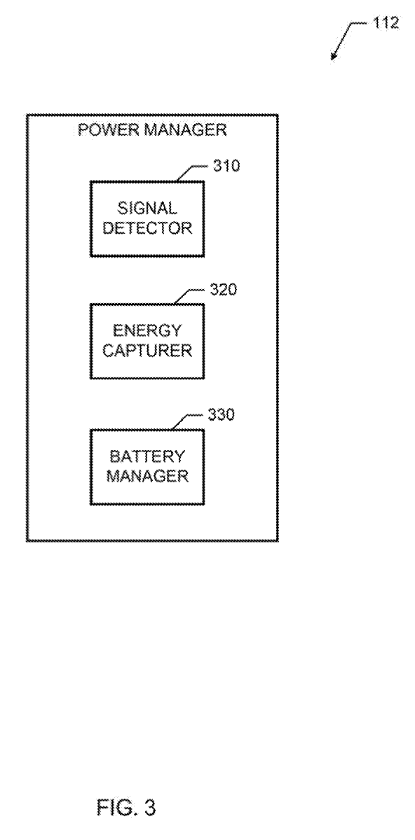

FIG. 2 is a block diagram of an example user authenticator 110 that may be used to implement the user authenticator 110 of FIG. 1. The example user authenticator 110 of FIG. 2 includes a power manager 112, a user monitor 114, and an authentication manager 210. The example power manager 112 and the user monitor 114 of FIG. 2 may be used to implement the power manager 112 and the user monitor 114 of FIG. 1. Accordingly, the power manager 112 and the user monitor 114 are implemented in accordance with the teachings of this disclosure. An example implementation of the power manager 112 of FIG. 2 is further described below in connection with FIG. 3.

The example user monster 114 monitors interactions between the user authenticator 110 and a user, in examples disclosed herein, a user is an individual wearing the user authenticator 110. In some examples, the user authenticated 110 is implemented by a ring that is fitted to a finger of the user. In examples disclosed herein, the user monitor 114 may detect the presence of a user using a user interface (e.g., a display, buttons, etc.) of the user authenticate 110. In some examples, the user monitor 114 may use sensors (e.g., accelerometers, haptic sensors, etc.) to detect the touch of a user. For example, a haptic sensor may detect that the user is wearing the user authenticated 110. In some examples, the user monitor 114 may detect touches of the user (e.g., taps on the user authenticated 110) using the sensors. The example touches by the user may be used to confirm that the user is an authorized user of the user authenticated 110. For example, a user may tap the user authenticated 110 in a designated sequence (e.g., Similar to Morse code) to indicate that the user is the authorized user, in such an example, the user monitor 114 may monitor for touches (or taps) and detect the sequence to confirm to the authentication manger 210 that the proper or authorized user is wearing the user authenticated 110. Additionally or alternatively, the user monitor 114 may detect authentication gestures using information from an accelerometer or other movement sensor. For example, the user may place the user authenticator 110 on his or her finger and make a designated hand signal to authenticate that the user is associated with the user authenticator 110 or authorized to use the user authenticated 110. In some examples, the user monitor 114 may use biometric authentications techniques to detect that a proper or authorized user is wearing the user authenticator 110. For example, the user authenticator 110 may include a finger print scanner (e.g., on the inside of the user authenticator ring 110) or monitor heart rate or heart beats of a user. Any suitable technique may be used for biometric authentication.

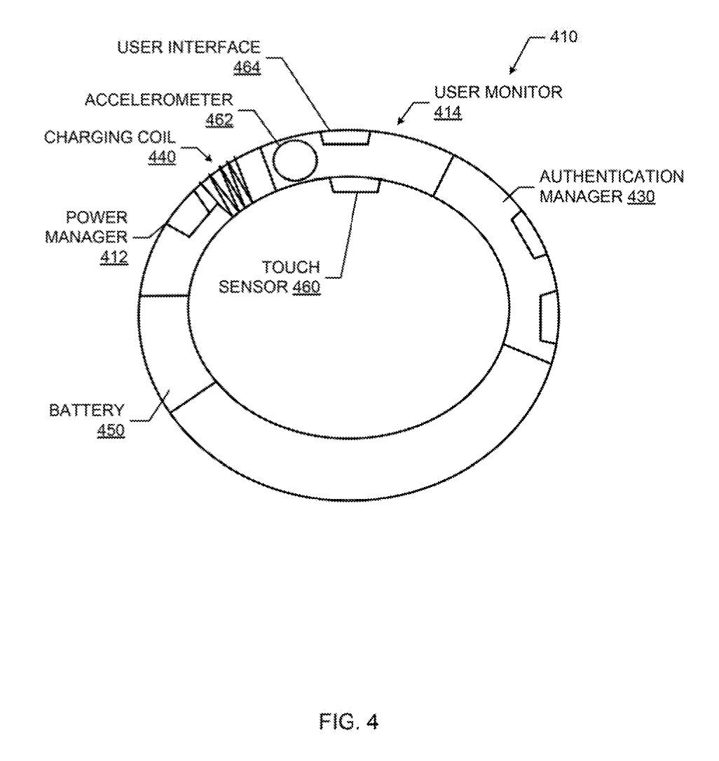

In examples disclosed herein, the user monitor 114 monitors user interaction or movement to determine that the user authenticator 110 is being worn by the user. Accordingly, the user monitor 114 may receive information from sensors (e.g., accelerometers, haptic sensors, temperature sensors, light sensors, pressure sensors, such as a capacitive pressure sensor etc.) of the user authenticator 110, Based on information received from the sensors, the user monitor 114 may determine that a user is or is not wearing the user authenticator 110 (or that the user authenticator 110 has been removed from the user). For example, the user monitor 114 may determine that the user has removed the user authenticator 110 based on information retrieved or received from a capacitive pressure sensor located inside of the user authenticator 110 (see FIG. 4). In some examples, the user monitor 114 may detect sliding of the ring over a portion of a user's body (e.g., a fingertip) by detecting a fingerprint of the user. Accordingly, the user authenticator 110 may implement sensors (e.g., similar to a finger print scanner) to detect at which part (e.g., the base or the finger tip) of the users finger (or body) a ring is positioned.

In examples disclosed herein, when the user monitor 114 determines or detects that the user authenticator 110 has been removed from the user or is not being worn by the user, the user monitor 114 may indicate the same to the power manager 112 or the authentication manager 210 to disable or deactivate functions (e.g., authorization functions, communication functions, sensor functions, etc.) of the user authenticator. In such examples, the power manager 112 may shutdown the user authenticator 110 or place the user authenticator 110 in a standby state (e.g., a low power state). Furthermore, the authentication manager 210 may no longer provide or allow authentication information to be retrieved by an authorization device or transmitted to an authorization device. Accordingly, the user authenticator 110 may not be able to be used by unauthorized persons, in some examples, the user authenticator 110 may be shutdown using out-of-band methods (e.g., from an external device (e.g., a mobile phone, a computer, etc.) via a wireless communication signal).

The example authentication manager 210 of FIG. 2 facilitates authenticating a user wearing the user authenticator 110 or a user associated with the user authenticator 110. Accordingly, the authentication manager 210 functions as a password manager, key manager, identification manager, etc. to provide authorization to authorization devices (e.g., the authorization device 120) to allow the user to access secure devices (e.g., the secure device 130) or secure locations (e.g., a secure area locked by the secure device 130). In some examples, the authentication manager 210 may detect gestures of intent to activate or transmit identification information, passwords, pass codes, security information, etc. For example, the authentication manager 210 may receive information from a movement sensor (e.g., an accelerometer) of the user authenticator 110 to detect the gestures of intent. When a particular gesture of intent is detected (e.g., reaching out for a door handle with a hand of the user authenticator 110, waving a hand of the user authenticator 110, etc.), the authentication manager 210 may detect requests for security information or transmit security information to/from authorization devices (e.g., the authorization device 120).

While an example manner of implementing the user authenticator 110 of FIG. 1 is illustrated in FIG. 2, at least one of the elements, processes or devices illustrated in FIG. 2 may be combined, divided, re-arranged, omitted, eliminated or implemented In any other way. Further, the power manager 112, the user monitor 114, the authentication manager 210 or, more generally, the example user authenticator 110 of FIG. 2 may he implemented by hardware or any combination of hardware and executable instructions (e.g., software or firmware). Thus, for example, any of the power manager 112, the user monitor 114, the authentication manager 210 or, more generally, the example user authenticator 110 could be implemented by at least one of an analog or digital circuit, a logic circuit, a programmable processor an application specific integrated circuit (ASIC), a programmable logic device (PLD) or a field programmable logic device (FPLD). When reading any of the apparatus or system claims of this patent to cover a purely software or firmware implementation, at feast one the power manager 112, the user monitor 114, or the authentication manager 210 is/are hereby expressly defined to include a tangible computer readable storage device or storage disk such as a memory, a digital versatile disk (DVD), a compact disk (CD), a Blu-ray disk, etc, storing the executable instructions. Further still, the example user authenticator 110 of FIG. 2 may include at least one element, process, or device in addition to, or instead of, those illustrated in FIG. 2, or may include more than one of any or all of the illustrated elements, processes and devices.

FIG. 3 is a block diagram: of an example power manager 112 that may be used to implement the power manager 112 of FIG. 1 or 2. The example power manager 112 of FIG. 3 includes a signal detector 310, an energy capturer 320, and a battery manager 330. In examples disclosed herein, the signal detector 310 detects signals (e.g., NFC signals, BLE signals, etc.) within range of the user authenticator 110 and instructs the energy capturer 320 to capture energy from the signals and store the energy in the battery manager 330 to provide power to the user authenticator 110.

The example signal detector 310 of FIG. 3 detects that the user authenticator 110 is within range of an authorization device (e.g., the authorization device 120) or in communication with an authorization device. For example, the signal detector 310 may monitor frequencies or frequency ranges of the radio spectrum (e.g., NFC frequencies, BLE frequencies, etc.) to detect signals from the authorization device 120. In some examples, the signal defector 310 may detect energy being captured or stored in an inductive charging coil of the user authenticator 110. Upon detection of such signals, the signal detector 310 may instruct the energy capturer 320 or battery manager 330 to activate or begin harvest energy from the detected signals to store power in a battery of the user authenticator 110.

The energy capturer 320 of FIG. 3 captures energy from signals (e.g., NFC signals, BLE signals, etc.) detected by the signal detector 310. In some examples, the energy capturer 320 is always or continuously (or nearly continuously) capturing energy from received signals and therefore may not necessarily capture energy in response to receiving instructions from the signal detector 310 to activate or begin capturing energy. The energy capturer 320 in the illustrated example of FIG. 3 may be any type of circuit or device to capture energy from signals received from an authorization device (e.g., the authorization device 120). For example, the energy capturer 320 may include an inductive charging coil wrapped within or around the ring or a circumference of the ring and a capacitive matching circuit to tune the coil to resonate at a designated frequency (e.g., 13.58 MHz). Accordingly, the energy capturer 320 may harness energy to charge (or recharge) a battery of the user authenticator 110 from signals received from a variety of NFC authorization devices or high frequency (HF) RFID authorization devices. Accordingly, in examples disclosed herein, when the user authenticator 110 comes within range of the authorization device 120 of FIG. 1, the energy capturer 320 may harvest energy from signals transmitted by the authorization device 120 and forward the energy to a battery for storage to power the user authenticator 110.

The example battery manager 330 of FIG. 3 manages battery charging by regulating flow of energy (or current) captured by the energy capturer 320. The example battery manager 330 may include linear voltage converters for maintaining power supply voltages to components of the user authenticator 110. In some examples, the battery manager 330 may shutdown power or regulate power to components (e.g., sensors, communication circuits, processors, etc.). For example, if the user monitor 114 determines that the user authenticator 110 is removed from a user's finger, the battery manager 330 may shutdown or limit power to certain components of the user authenticator 110. On the other hand, when the user monitor 114 determines that an authorized user is wearing the user authenticator 110, the battery manager 330 may restore power to appropriate components of the user authenticator 110. Accordingly, the battery manager 330 maintains power storage and distribution for a battery (e.g., a small form factor 10 mAh battery) of the user authenticator 110.

While an example manner of implementing the power manager 112 of FIG. 1 or 2 is illustrated in FIG. 3, at least one of the elements, processes or devices illustrated in FIG. 3 may be combined, divided, re-arranged, omitted, eliminated or implemented in any other way. Further, the signal detector 310, the energy capturer 320, the battery manager 330 or, more generally, the example power manager 112 of FIG. 3 may be implemented by hardware or any combination of hardware and executable instructions (e.g., software or firmware). Thus, for example, any of the signal detector 310, the energy capturer 320, the battery manager 330 or, more generally, the example power manager 112 could be implemented by at least one of an analog or digital circuit, a logic circuit, a programmable processor, an application specific integrated circuit (ASIC), a programmable logic device (PLD) or a field programmable logic device (FPLD). When reading any of the apparatus or system claims of this patent to cover a purely software or firmware implementation, at least one the signal detector 310, the energy capturer 320, or the battery manager 330 is/are hereby expressly defined to include a tangible computer readable storage device or storage disk such as a memory, a digital versatile disk (DVD), a compact disk (CD), a Blu-ray disk, etc, storing the executable instructions. Further still, the example user authenticator 110 of FIG. 2 may include at feast one element, process, or device in addition to, or instead of, those illustrated in FIG. 2, or may include more than one of any or all of the illustrated elements, processes and devices.

FIG. 4 is an example implementation of a user authenticator ring 410, which may be used to Implement the user authenticator 110 of FIG. 1 or 2. In the illustrated example of FIG. 4, the portions of the user authenticator ring 410 are representative of components that are constructed in accordance with aspect(s) of this disclosure. Accordingly, the example components of the user authenticator ring 410 of FIG. 4 are not drawn to scale and are merely-representative of example implementations of components of the user authenticator 110 of FIG. 1 or 2. In some examples, components of the user authenticator 110 of FIG. 1 or 2, such as the components of the user authenticator ring 410, may be printed by a three-dimensional (3D) printer or may be enclosed with In a 3D printed enclosure.

The example user authenticator ring 410 of FIG. 4 includes an example power manager 412, an example user monitor 414, and an example authentication manager 420. The example power manager 412 of a FIG. 4 includes an inductive charging coil 440 for harvesting energy from signals received from other devices (e.g., NFC devices or RFID devices such as the authorization device 120). The example inductive charging coil 440 of FIG. 4 is wrapped around a circumference of a portion of the user authenticator ring 410, as illustrated. In some examples, the inductive charging coil 440 may be wrapped around tie entirety of the example user authenticator ring 410. The inductive charging coil 440 may be focused within an external cover or coating of the user authenticator ring 410. The power manager 412 may regulate flow of energy or current from the inductive charging coil 440 to a battery 450. The example battery 450 may be any suitable type of battery, such as a lithium-ion battery, for powering the user authenticator ring 410.

The example user monitor 414 includes a touch sensor 460. The example touch sensor 480 may be a capacitive touch sensor capable of detecting when a user's finger (or other body part) is touching the inside of the user authenticator ring 410. Accordingly, when the touch sensor 460 detects a touch from a user, it can be inferred that a user a wearing the user authenticator ring 410. The example user monitor 414 may also include or receive information from an accelerometer 462 of the user authenticator ring 410. For example, the user monitor 414 may determine or analyze movement of the user authenticator ring based on measurement information received from the accelerometer 482 to identify gestures of intent performed by the user. As another example, the accelerometer 462 may be used to detect when a user taps the user authenticator ring 410 to confirm that the user is an authorized user associated with the user authenticator ring 410.

The example authentication manager 430 of FIG. 4 provides authentication information to authorization devices to request or enable access to secure devices of the corresponding authorization devices. The authentication manager 430 may communicate via communication interfaces 470 (e.g., antennae, transceivers, etc.) of the user authenticator ring 410. The authentication manager 430 of FIG. 4 may include a database 472 to store authentication information associated with an authorized user of the user authenticator ring 410. For example, the database 472 may store passwords, digital keys, identification information (e.g., name, social security number, birthdate, etc.) of the user, security information (e.g., employee identification number, clearance level or information, etc.). In some examples, the database may be located in a cloud or network associated with the user authenticator ring 410. In such an example, the user authenticator ring 410 may retrieve such information (e.g., via wireless communication protocols, via another device, such as a mobile device or smartphone in communication with the user authenticator ring 410, etc.). The authentication manager 430 may determine which authentication information is to be provided to an authorization device (e.g., the authorization device 120) based on information associated with the authorization device. For example, the authorization device 120 may be equipped to provide identification information, location information, etc, associated with a secure device that may be authorized using the user authenticator ring 410. In some examples, the authentication manager 430 may retrieve and transmit specific authentication information based on gestures of intent made by the user (e.g., reaching for a door, waving a hand, etc.).

Accordingly, the user authenticator ring 410 of FIG. 4 may be used to implement the user authenticator 110 of FIG. 1. The user authenticator ring 410 may be worn by a users finger or other body part to authenticate that the user Is authorized to access secure devices (e.g., computers, smartphones, etc.) or secure locations (e.g., physical areas locked by a secure device, such as a lock). In examples disclosed herein, when the user authenticator ring 410 comes within range of an authorization device (e.g., an NFC device, a BLE device, an RFID device, etc.) the user authenticator ring 410 verifies that, a user wearing the user authenticator ring and attempting to access a secure device (e.g., the secure device 130) in communication with the authorization device (e.g., the authorization device 120) is an authorized user of the user authenticator ring 410. Assuming that the user wearing the user authenticator ring 410 has appropriate credentials or authorization to access the secure device, the user authenticator 410 may gain access without necessarily needing to manually enter a password, physical key, digital key, etc.

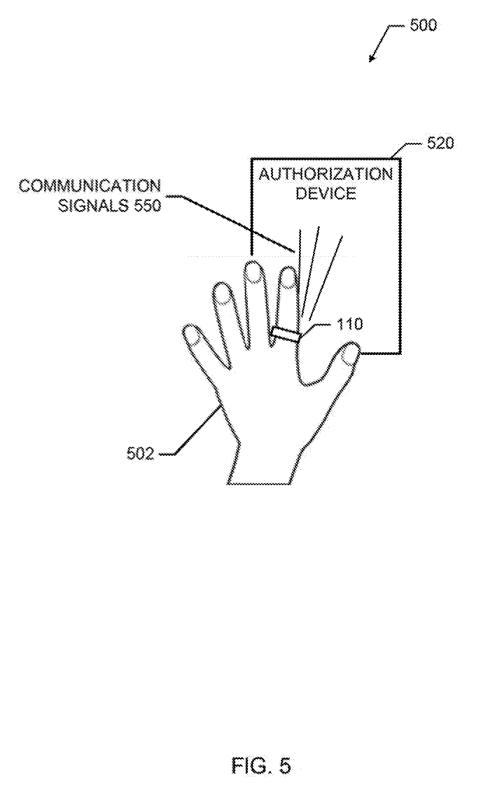

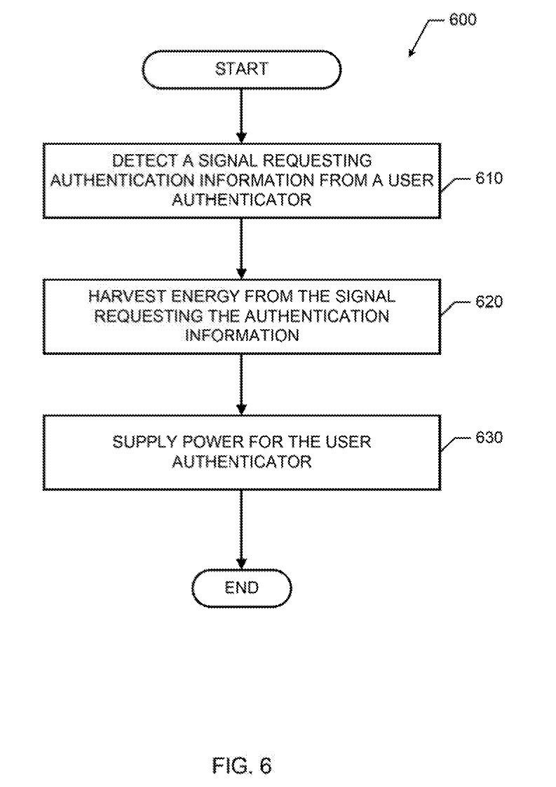

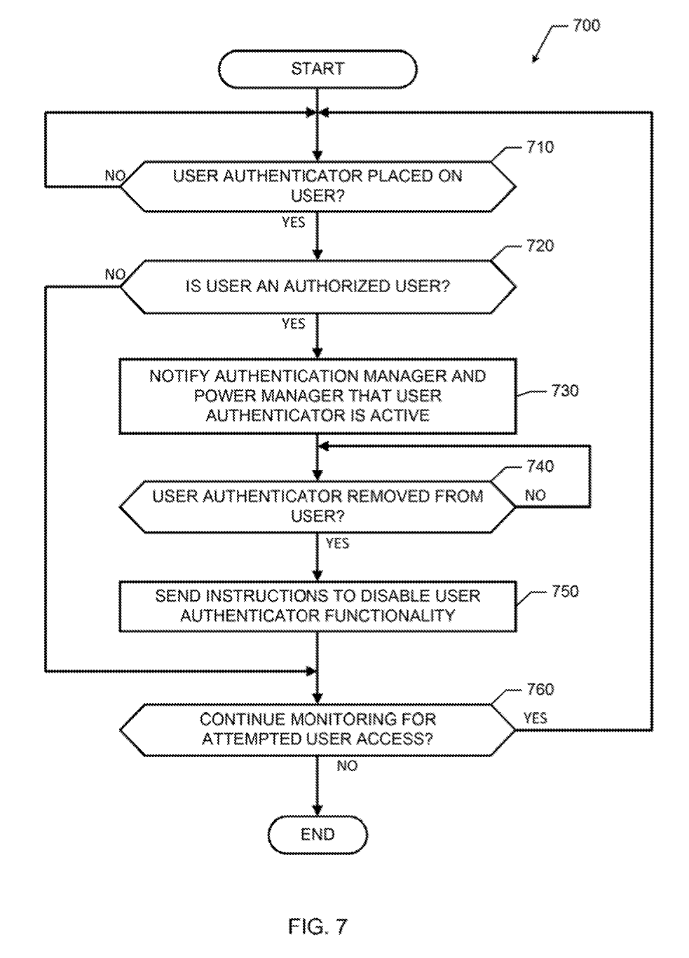

FIG. 5 illustrates an example environment 500 of use in which the user authenticator of FIG. 1 or 2 or the user authenticator ring 410 of FIG. 4 may be implemented. In the illustrated example of FIG. 5, a user 502 is wearing a user authenticator 110 on his finger. The example user authenticator 110 authenticates that the user 502 is an authorized user of the user authenticator 110. The example authorization device 520 enables access (e.g., unlocks) to a secure device to allow the user to access a secure location, a secure electronic device (e.g., a computer, a smartphone., etc.), a secure virtual environment (e.g., a secure website, a secure application, etc.) of an electronic device, etc.

The illustrated example of FIG. 5 shows communication signals 550 sent from the authorization device to the user authenticator 110. The communication signals 550 are sent from the authorization device 520 to the user authenticator 110 to retrieve or request authentication information from the user authenticator 110. Such information may be transmitted from the user authenticator 110 via communication interfaces (e.g., NFC transponders, BLE communication devices, etc.). The user authenticator 110, in examples disclosed herein, harvests energy from the communication signals 550.

In examples disclosed herein, when the user authenticator 110 is worn on a hand of a user, if may frequently come into proximity with authorization devices, similar to the authorization device 520. For example, if the authorization device 520 is to unlock a door to a secure location (e.g., a locked building, a locked vehicle, etc.), the authorization device 520 may be proximately located near a door handle or door lock such that the hand of the user 502, and thus, the user authenticator 110, comes within range of the authorization device 520 when attempting to open the door. Accordingly, in such an example, when the user 520 reaches to open the example door, the user authenticator 110 may provide authentication information to unlock the door and harvest energy from the communication signals 550 received from the authorization device 520 to charge a battery of the user authenticator 110.

As another example, the authorization device 520 of FIG. 6 may he an NFC device of a mobile phone. While holding the mobile phone, the hand of the user 502, and thus the user authenticator 110, is within range of the authorization device 520. Accordingly, in such an example, while the user 502 is holding the mobile phone and the authorization device 520 is sending signals requesting authentication information (e.g., to unlock the device, to access a secure application or a secure website, etc.) from the user authenticator 110, the user authenticator 110 may harvest energy from the signals from the authorization device 520 to charge a battery of the user authenticator 110.

A flowchart representative of example machine readable instructions for implementing the power manager 112 of FIG. 3 is shown in FIG. 6. In this example, the machine readable instructions comprise a program/process for execution by a processor such as the processor 812 shown in the example processor platform 800 discussed below in connection with FIG. 8. The program/process may be embodied in executable instructions (e.g., software) stored on a tangible computer readable storage medium such as a CD-ROM a floppy disk, a hard drive, a digital versatile disk (DVD), a Blu-ray disk, or a memory associated with the processor 812, but the entire program/process or parts thereof could alternatively be executed by a device other than the processor 812 or embodied in firmware or dedicated hardware. Further, although the example program is described with reference to the flowchart illustrated in FIG. 6, many other methods of implementing the example power manager 112 may alternatively be used. For example, the order of execution of the blocks may be changed, or some of the blocks described may be changed, eliminated, or combined.

The example process 600 of FIG. 6 begins with an initiation of the power manager 112 of FIG. 1, 2, or 3 (e.g., upon startup, upon instructions from a user, upon startup of a device implementing the power manager 112 (e.g., the user authenticator 110), etc.). The example process 600 of FIG. 6 may be executed to manage power for the user authenticator 110 of FIG. 1 or 2 the user authenticator ring 410 of FIG. 4. At block 810 of FIG. 8, the signal detector 310 detects a signal (e.g., an NFC signal, a BLE signal, etc.) requesting authentication information from the user authenticator 110. The example signal may be sent from an authorization device (e.g., the authorization device 120). The example signal detector 310 may detect energy in an inductive charging coil of the user authenticator or may monitor the radio spectrum surrounding the user authenticator for communication signals from the authorization device 120,

In the example process 800 of FIG. 6, at block 620, the energy capturer 320 harvests energy from the signal requesting the authentication information. For example, the energy capturer 320 may absorb energy from the signal via an inductive charging coil and a capacitive matching circuit resonating at a designated frequency to capture energy from the signal. At block 830, the battery manager 830 supplies power for the user authenticator 110, For example, the battery manager 330 may regulate the flow of energy from the energy capturer 320 to a battery to buffer the energy and further power components (e.g., sensors, communication interfaces, user interfaces, authorization/authentification functionality, etc.) of the user authenticator 110, After block 830, the example process 600 ends.

A flowchart representative of example machine readable instructions for Implementing the user monitor 114 of FIG. 1 or 2 is shown in FIG. 7. In this example, the machine readable instructions comprise a program/process for execution by a processor such as the processor 812 shown in the example processor platform 800 discussed below in connection with FIG. 8. The program/process may be embodied in executable instructions (e.g., software) stored on a tangible computer readable storage medium such as a CD-ROM, a floppy disk, a hard drive, a digital versatile disk (DVD), a Blu-ray disk, or a memory associated with the processor 812, but the entire program/process or parts thereof could alternatively be executed by a device other than the processor 812 or embodied in firmware or dedicated hardware. Further, although the example program is described with reference to the flowchart illustrated in FIG. 7, many other methods of implementing the example user monitor 114 may alternatively be used. For example, the order of execution of the blocks may be changed, or some of the blocks described may be changed, eliminated, or combined,

The example process 700 of FIG. F begins with an initiation of the user monitor 114 (e.g., upon startup, upon instructions from a user, upon startup of a device Implementing the user monitor 114 (e.g., the user authenticator 110), etc.). At block 710, the user monitor 114 monitors the user authenticator 110 to determine whether the user authenticator 110 has been placed on a user. For example, at block 710, the user monitor 114 may monitor measurements from sensors (e.g., pressure sensors, movement sensors, temperature sensors, etc.) of the user authenticator 110. If the user monitor 114 does not determine that the user authenticator 110 has been placed on a user control returns (or remains) at block 710 to continue monitoring the user authenticator 110.

If, at block 710, the user monitor 114 determines that the user authenticator 110 has been placed on a user (e.g., on a finger of the user), the user monitor 114 determines whether the user wearing the user authenticator 110 is an authorized user (block 720). For example, at block 720, the user monitor 114 may monitor movement sensors for a period of time (e.g., 5 seconds, 30 seconds, 1 minute, etc.) to allow the user to make a gesture of intent (e.g., a designated movement) indicating that he is an authorized user of the user authenticator or to allow the user to tap the user authenticator 110 to detect a code (e.g., similar to Morse code). Accordingly, at block 720 the user monitor 114 may store, monitor, and detect authorization processes using sensors of the user authenticator 110. If the user monitor 114 determines that the user is not an authorized user, control advances to block 780 (discussed further below).

If, at block 720, the user monitor 114 determines that the user wearing the user authenticator 110 is an authorized user, the user monitor 114, at block 730, may notify the authentication manager 210 and the power manager 112 that the user authenticator 110 is active (i.e., ready to authenticate the user and to unlock secure devices). For example, in response to the notification of block 730, the authentication manager 210 may begin to monitor for signals requesting authentication information or provide authentication information and the power manager 112 may begin providing power to other components (e.g., sensors, interfaces, communication devices, etc.) and harvesting energy from communication signals.

At block 740, the user monitor 114 determines whether the user authenticator has been removed from the user. For example, at block 740, the user authenticator 110 may monitor sensors (e.g., pressure sensors, capacitive touch sensors, temperature sensors, etc.) of the user authenticator 110 to determine that the user authenticator 110 is no longer being worn by the user, More specifically, if a pressure sensor is no longer detecting pressure (e.g., from a user's finger) or if a movement sensor does not detect movement for a period of time, the user monitor 114 may determine that the user is no longer wearing the user authenticator 110, if the user monitor 114 determines that the user monitor has not been removed from the user, control remains at block 740. If, at block 740, determines that the user authenticator 110 has been removed from the user, the user monitor 114 may send instructions to disable functions of the user authenticator 110, For example, at block 750, the user monitor 114 may instruct the authentication manager 210 to shut down or no longer provide authentication information to authorization devices. Accordingly, after block 750 the user authenticator may enter a standby state or lock mode that requires an authorized user to unlock or activate the user authenticator 110 (e.g., using processes similar to those disclosed in connection with block 720).

At block 780 of the example process 700 of FIG. 7, the user monitor 114 determines whether to continue to monitor for a user attempting to access (e.g., to wear, to activate, etc.) the user authenticator 110. If the user monitor 114 is to continue to monitor for access to the user authenticator 110, control returns to block 710. If, at block 780, the user monitor 114 determines that it is not to continue monitoring attempted user access, the example process 700 ends. For example after block 760, the user authenticator may shutdown or enter a lock mode.

As mentioned above, the example processes of FIG. 6 or 7 may be implemented using coded instructions (e.g., computer or machine readable instructions) stored on a tangible computer readable storage medium such as a hard disk drive, a flash memory, a read-only memory (ROM), a compact disk (CD), a digital versatile disk (DVD), a cache, a random-access memory (RAM) or any other storage device or storage disk m which information is stored for any duration (e.g., for extended time periods, permanently, for brief instances, for temporarily buffering, or for caching of the information). As used herein, the term tangible computer readable storage medium is expressly defined to include any type of computer readable storage device or storage disk and to exclude propagating signals and to exclude transmission media. As used herein, “tangible computer readable storage medium” and “tangible machine readable storage medium” are used interchangeably. Additionally or alternatively, the example processes of FIG. 6 or 7 may be implemented using coded instructions (e.g., computer or machine readable instructions) stored on a non-transitory computer or machine readable medium such as a hand disk drive, a flash memory, a read-only memory, a compact disk, a digital versatile disk, a cache, a random-access memory or any other storage device or storage disk in which information Is stored for any duration (e.g., for extended time periods, permanently, for brief instances, for temporarily buffering, or for caching of the information). As used herein, the term non-transitory computer readable medium is expressly defined to include any type of computer readable storage device or storage disk and to exclude propagating signals and to exclude transmission media. As used herein, when the phrase “at least” is used as the transition term in a preamble of a claim, it is open-ended in the same manner as the term “comprising” is open ended. As used herein the term “a” or “an” may mean “at least one,” and therefore, “a” or “an” do not necessarily limit a particular element to a single element when used to describe the element. As used herein, when the term “or” is used in a series, if is not, unless otherwise indicated, considered an “exclusive or.”

FIG. 8 is a block diagram of an example processor platform 800 capable of executing the instructions of FIGS. 6 and 7 to implement the power manager 112 of FIG. 3, the user monitor of FIG. 1 or 2, or more generally, the user authenticator of FIG. 1 or 2. The example processor platform 800 may be or may be included in any type of apparatus, such as a smart wearable device or any other type of computing device.

The processor platform 800 of the illustrated example of FIG. 8 includes a processor 812. The processor 812 of the illustrated example is hardware. For example, the processor 812 can be implemented by at least one integrated circuit, logic circuit, microprocessor or controller from any desired family or manufacturer.

The processor 812 of the illustrated example includes a local memory 813 (e.g., a cache). The processor 812 of the illustrated example is in communication with a main memory including a volatile memory 814 and a non-volatile memory 818 via a bus 818, The volatile memory 814 may be implemented by random access memory (e.g., Dynamic Random Access Memory (DRAM)). The non-volatile memory 816 may be implemented by flash memory or any other desired type of memory device.

The processor platform 800 of the illustrated example also includes an interface circuit 820. The interface circuit 820 may be implemented by any type of interface standard, such as an Ethernet Interface, a universal serial bus (USB), or a peripheral component interconnect (PCI) express interface.

In the illustrated example, at least one input device 822 is connected to the interface circuit 820, The Input device(s) 822 permit(s) a user to enter data and commands into the processor 812. The input device(s) can be Implemented by, for example, an audio sensor, a microphone, a button, a touchscreen, a track-pad, a trackball, an accelerometer, or a voice recognition system.

At least one output device 824 is also connected to the interface circuit 820 of the illustrated example. The output device(s) 824 can be implemented, for example, by display devices (e.g., a light emitting diode (LED) display, an organic light emitting diode (OLEO), a liquid crystal display, a touchscreen, a tactile output device, a light emitting diode (LED), a printer or speakers). The interface circuit 820 of the illustrated example, thus, may include a graphics driver card, a graphics driver chip, or a graphics driver processor.

The interface circuit 820 of the illustrated example also includes a communication device such as a transmitter, a receiver, a transceiver, a modem or network interface card to facilitate exchange of data with external machines (e.g., computing devices of any kind) via a network 828 (e.g., an Ethernet connection, a digital subscriber line (DSL), a telephone line, coaxial cable, a cellular telephone system, etc.).

The processor platform 800 of the illustrated example also Includes at least one mass storage device 828 for storing executable instructions (e.g., software) or data. Examples of such mass storage device(s) 828 include floppy disk drives, hard drive disks, compact disk drives, Blu-ray disk drives, RAID systems, and digital versatile disk (DVD) drives.

The coded instructions 832 of FIG. 6 or 7 may be stored In the mass storage device 828, In the local memory 813 In the volatile memory 814, in the non-volatile memory 816, or on a removable tangible computer readable storage medium such as a CD or DVD.

From the foregoing, it will be appreciated that the above disclosed methods, apparatus and articles of manufacture involve a user authenticator to provide access to secure devices by providing authentication information while managing power and harvesting energy from communication signals requesting or retrieving authentication information. Accordingly, examples disclosed herein allow for a user authenticator to recharge itself when within range of an authorization device (e.g., a NFC device, an RFID device, a BLE device). In some examples, sensors of a user authenticator am monitored to determine user interactions (e.g., movement, touching, tapping, etc.) with the user authenticator and to enable or disable functionality (e.g., authorization, power management, communication, etc.) of the user authenticator based on the determine user interaction. In examples disclosed herein, the user authenticator may be a ring worn by a user that allows for frequent proximity to authorization devices that may emit energy to be harvested by the user authenticator.

Although certain example methods, apparatus and articles of manufacture have been disclosed herein, the scope of coverage of this patent is not limited thereto. On the contrary, this patent covers ail methods, apparatus and articles of manufacture fairly falling within the scope of the claims of this patent.

What is claimed is:

1. A method comprising:
detecting a signal requesting authentication information from a user authenticator worn by a user;
harvesting energy from the signal requesting the authentication information; and
supplying power for the user authenticator, the power generated from the energy.

2. The method as defined In claim 1, further comprising sending the authentication information to an authorization device to enable access to a secure device.

3. The method as defined in claim 1, further comprising;
determining that the user wearing the user authenticator is an authorized user of the user authenticator.

4. The method as defined in claim 3, wherein the user is authenticated as the authorized user based on measurements taken by an accelerometer of the user authenticator, the measurements taken in response to tapping the user authenticator or making gestures of intent.

5. The method as defined in claim 1, further comprising:
determining that the user authenticator is removed from the user; and
ceasing supplying the power to the user authenticator or disabling a function of the user authenticator.

6. An apparatus comprising:
an authentication manager to provide authentication information to an authorization device to enable access to a secure device in response to detecting a signal from the authorization device for the authentication information;
a power manager to harvest energy from the signal to power the apparatus.

7. The apparatus as defined in claim 6, wherein the apparatus is a ring worn on a finger of a user, the ring further comprising
a user monitor to:
determine that the apparatus has been removed from the finger of the user; and
prevent the authentication manager from providing the authentication information to authorization devices based-on the interactions until the ring is replaced on the finger of the user,

8. The apparatus as defined in claim 7, further comprising a capacitive touch sensor that indicates that the apparatus has been removed from the finger of the user.

9. The apparatus as defined in claim 6, wherein the power manager comprises an inductive charging coil and a capacitive matching circuit tuned to harvest the energy from the request signal.

10. The apparatus as defined in claim 6, wherein the request signal comprises a near field communication signal or a Bluetooth low energy signal.

11. The apparatus as defined in claim 6, wherein the secure device comprises one of a physical lock securing a location or virtual lock of an electronic device.

12. A non-transitory computer readable storage medium comprising instructions that, when executed., cause a machine to at least:
harvest energy from a signal received from an authorization device, the signal requesting authentication information to unlock a secure device;
send the authentication information to the authorization device in response to receiving the signal.

13. The non-transitory computer readable storage medium of claim 12, wherein the machine comprises a wearable device comprising the user authenticator and the instructions, when executed, further cause the machine to:
prior to sending the authentication information to the authorization device, determine that a user wearing the user authenticator is an authorized user of the user authenticator.

14. The non-transitory computer readable storage medium of claim 13, wherein the instructions: when executed, further cause the machine to:
detect a gesture of intent form the user based on movement measurements from an accelerometer; and
send the authentication information to the authorization device in response to detecting the gesture of intent.

15. The non-transitory computer readable storage medium of claim 12, wherein the signal comprises a near field communication signal or a Bluetooth low energy signal.

18. A method comprising:
determining that a user authenticator has been placed on a user;
enabling the user authenticator to provide authentication information to authorization devices in response to determining that the user is an authorized user; and
preventing the user authenticator from providing the authentication information in response to detecting that the user authenticator has been removed from the user.

17. The method as defined in claim 16. further comprising:
monitoring measurements of a pressure sensor of the user authenticator; and
determining from the measurements of the pressure sensor that the user authenticator has been placed on the user or removed from the user.

18. The method as defined in claim 16, further comprising:
monitoring measurements of an accelerometer of the user authenticator; and
determining from the measurements of the accelerometer that the user authenticator has been placed on the user.

19. The method as defined in claim 16, further comprising:
harvesting energy from signals received from the authorization devices, the signals requesting the authentication information; and
supplying power for the user authenticator, the power generated from the energy.

20. The method as defined In claim 16, further comprising:
determining that the user authenticator has been placed on a finger of the user, the user authenticator being implemented by a ring fitted to the finger.
